(19) United States
(12) Patent Application Publication
(10) Pub. No.: US 2023/0079496 A1
(43) Pub. Date: Mar. 16, 2023

(54) TIRE

(71) Applicant: Sumitomo Rubber Industries, Ltd., Kobe-shi (JP)

(72) Inventor: Koichi NAKAJIMA, Kobe-shi (JP)

(73) Assignee: Sumitomo Rubber Industries, Ltd., Kobe-shi (JP)

(21) Appl. No.: 17/897,228

(22) Filed: Aug. 29, 2022

(30) Foreign Application Priority Data
Sep. 2, 2021 (JP) 2021-143403

(51) Int. Cl. B60C 11/03

(52) U.S. Cl. CPC B60C 11/03; B60C 2011/0341; B60C 2011/0358

(57) ABSTRACT

A tire has a tread portion that can include a first tread ground contact end on one side in a tire axial direction, a first shoulder circumferential groove closest to the first tread ground contact end, and a first shoulder land portion demarcated to be disposed outwardly of the first shoulder circumferential groove in the tire axial direction. A plurality of first shoulder grove portions extending from the first shoulder circumferential groove to the first tread ground contact end e1 can be in the first shoulder land portion. A pair of first shoulder groove portions adjacent to each other in a tire circumferential direction can have different angles relative to the tire axial direction. The plurality of first shoulder groove portions can include a plurality of kinds of first shoulder groove portions having different first pitch lengths at a connecting portion to the first shoulder circumferential groove. A maximum value of the first pitch length can be 1.2 to 1.5 times an average of the first pitch lengths.

### CROSS-REFERENCE TO RELATED APPLICATION

The present application claims priority to Japanese patent application JP 2021-143403, filed on Sep. 2, 2021, the entire contents of which are incorporated herein by reference in its entirety.

### BACKGROUND

### Technical Field

The present disclosure relates to a tire.

### Background Art

Japanese Laid-Open Patent Publication No. 2020-132129 describes a tire having a tread portion. The tread portion has a first tread end, a plurality of main grooves extending continuously in the tire circumferential direction between the first tread end and a second tread end, and a plurality of land portions demarcated by the main grooves.

In the tire, although noise may be reduced, there is room for improving uneven wear resistance.

### SUMMARY

A tire according to the present disclosure is directed to a tire including a tread portion. The tread portion can include a first tread ground contact end on one side in a tire axial direction, a first shoulder circumferential groove closest to the first tread ground contact end, and a first shoulder land portion demarcated to be outward of the first shoulder circumferential groove in the tire axial direction. A plurality of first shoulder groove portions extending from the first shoulder circumferential groove to the first tread ground contact end can be in the first shoulder land portion. A pair of first shoulder groove portions adjacent to each other in a tire circumferential direction among the plurality of first shoulder groove portions can have different angles θ1 relative to the tire axial direction. The plurality of first shoulder groove portions can include a plurality of kinds of first shoulder groove portions having different first pitch lengths each representing a pitch length in the tire circumferential direction at a connecting portion to the first shoulder circumferential groove. A maximum value of the first pitch length can be 1.2 to 1.5 times an average of the first pitch lengths.

### BRIEF DESCRIPTION OF THE DRAWINGS

FIG. 1 is a development of a tread portion of a tire according to one or more embodiments of the disclosed subject matter;

FIG. 2 is a partially enlarged view of a first shoulder land portion in FIG. 1;

FIG. 3 is a partially enlarged view of a second shoulder land portion in FIG. 1;

FIG. 4 is a development of a tread portion of a tire according to another embodiment of the present disclosure;

FIG. 5 is a development of a tread portion of a tire according to still another embodiment of the present disclosure;

FIG. 6 is a partially enlarged view of a first shoulder land portion in FIG. 5;

FIG. 7 is a partially enlarged view of a second shoulder land portion in FIG. 5;

FIG. 8 is a development of a tread portion of a tire of conventional example 1; and

FIG. 9 is a development of a tread portion of a tire of conventional example 2.

### DETAILED DESCRIPTION

Embodiments of the present disclosure will be described below with reference to the drawings. It is to be understood that the drawings include exaggerated expressions and that the dimensional ratios are expressed so as to be different from those of the actual structure in order to aid in understanding of the present disclosure. The same or common components are denoted by the same reference characters throughout the embodiments, and repeated description is omitted. Furthermore, the embodiments and specific structures in the drawings are for aiding in understanding of the present disclosure, and the present disclosure is not limited to the illustrated specific structures.

The present disclosure has been made in view of the aforementioned circumstances, and an object of the present disclosure (among multiple objects) can be to provide a tire with enhanced noise performance without degrading uneven wear resistance.

### Tire (First Embodiment)

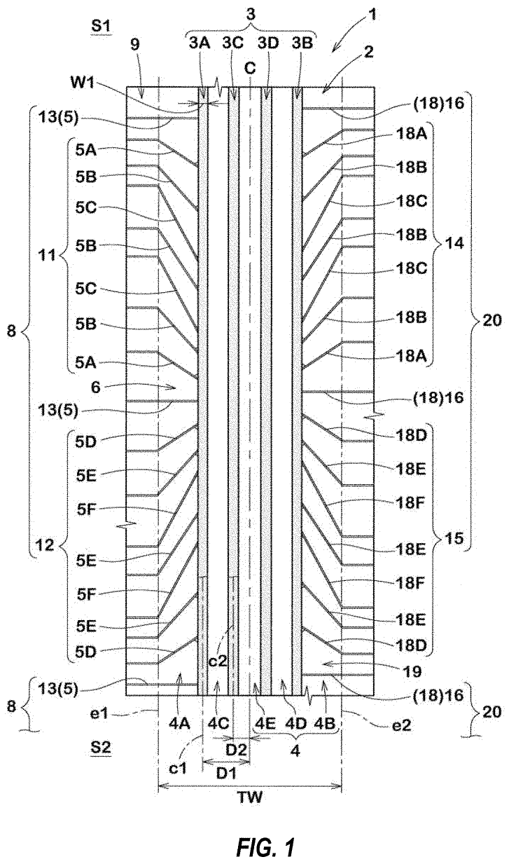

FIG. 1 is a development of a tread portion 2 of a tire 1 according to the present embodiment. In order to facilitate understanding of the present disclosure, circumferential grooves 3 and the like may be colored (i.e., shaded) in the drawings for the description herein. In the present embodiment, the tire 1 can be, for example, a pneumatic tire for a passenger car. However, the present disclosure is not limited thereto, and the tire 1 may be, for example, used as a heavy-duty pneumatic tire or a non-pneumatic tire (airless tire) the inside of which is not filled with pressurized air.

As shown in FIG. 1, the tire 1 has the tread portion 2. The tread portion 2 can include a first tread ground contact end e1 on one side in the tire axial direction and a second tread ground contact end e2 on the other side in the tire axial direction.

The first tread ground contact end e1 and the second tread ground contact end e2 are specified as the outermost ground contact positions in the tire axial direction when a normal load is applied to the tire 1 in a normal state and the tire 1 is brought into contact with a plane at a camber angle of 0° in a case where the tire 1 is a pneumatic tire.

The normal state can represent a state in which the tire 1 is mounted on a normal rim and is inflated to a normal internal pressure and no load is applied to the tire 1. In the description herein, unless otherwise specified, dimensions and the like of components of the tire 1 are represented as values measured in the normal state.

The “normal rim” can represent a rim that is defined by a standard, in a standard system including the standard on which the tire 1 is based, for each tire. Thus, examples of the normal rim include “standard rim” in the JATMA standard, “Design Rim” in the TRA standard, and “Measuring Rim” in the ETRTO standard.

The “normal internal pressure” can represent an air pressure that is defined by a standard, in a standard system including the standard on which the tire 1 is based, for each tire. Thus, examples of the normal internal pressure include “maximum air pressure” in the JATMA standard, the maximum value recited in the table “TIRE LOAD LIMITS AT VARIOUS COLD INFLATION PRESSURES” in the TRA standard, and “INFLATION PRESSURE” in the ETRTO standard.

The “normal load” can represent a load that is defined by a standard, in a standard system including the standard on which the tire 1 is based, for each tire. Thus, examples of the normal load include “maximum load capacity” in the JATMA standard, the maximum value recited in the table “TIRE LOAD LIMITS AT VARIOUS COLD INFLATION PRESSURES” in the TRA standard, and “LOAD CAPACITY” in the ETRTO standard.

[Circumferential Groove]

In the tread portion 2 of the present embodiment, a plurality of circumferential grooves 3 can extend continuously in the tire circumferential direction. The circumferential grooves 3 can allow water on a road surface to be smoothly discharged and allow resistance to hydroplaning to be enhanced during running on a wet road surface. A groove width W1 and a groove depth of each circumferential groove 3 can be set as appropriate. The groove width W1 can be set to be 4.0% to 8.0% of a tread width TW, for instance. The groove depth may be, for example, 5.0 to 10.0 mm.

In the present embodiment, the tread portion 2 can have four circumferential grooves 3 formed therein. Thus, five land portions 4 can be demarcated in the tread portion 2. However, the present disclosure is not limited thereto, and the tread portion 2 may have, for example, three land portions 4 demarcated by two circumferential grooves 3 or four land portions 4 demarcated by three circumferential grooves 3.

In the present embodiment, the circumferential grooves 3 can include a first shoulder circumferential groove 3A, a second shoulder circumferential groove 3B, a first center circumferential groove 3C, and a second center circumferential groove 3D.

The first shoulder circumferential groove 3A can be closest to the first tread ground contact end e1 as compared with the other circumferential grooves 3. The second shoulder circumferential groove 3B can be closest to the second tread ground contact end e2 as compared with the other circumferential grooves 3. A distance D1 from a tire equator C to a groove center line cl of each of the first shoulder circumferential groove 3A and the second shoulder circumferential groove 3B may be, for example, 20% to 25% of the tread width TW.

The first center circumferential groove 3C can be between the first shoulder circumferential groove 3A and the tire equator C. The second center circumferential groove 3D can be between the second shoulder circumferential groove 3B and the tire equator C. A distance D2 from the tire equator C to a groove center line c2 of each of the first center circumferential groove 3C and the second center circumferential groove 3D may be, for example, 6% to 15% of the tread width TW.

[Land Portion]

In the present embodiment, the land portions 4 can include a first shoulder land portion 4A and a second shoulder land portion 4B. The first shoulder land portion 4A can be demarcated to be outward of the first shoulder circumferential groove 3A in the tire axial direction. Meanwhile, the second shoulder land portion 4B can be demarcated to be outward of the second shoulder circumferential groove 3B in the tire axial direction.

In the present embodiment, the land portions 4 can include a first middle land portion 4C, a second middle land portion 4D, and a center land portion 4E. The first middle land portion 4C can be demarcated between the first shoulder circumferential groove 3A and the first center circumferential groove 3C. The second middle land portion 4D can be demarcated between the second shoulder circumferential groove 3B and the second center circumferential groove 3D. The center land portion 4E can be demarcated between the first center circumferential groove 3C and the second center circumferential groove 3D.

In the present embodiment, the first middle land portion 4C, the second middle land portion 4D, and the center land portion 4E can be formed as straight ribs extending linearly in the tire circumferential direction. In the present embodiment, in each of the first middle land portion 4C, the second middle land portion 4D, and the center land portion 4E, although lateral grooves and sipes extending so as to intersect the circumferential grooves 3 may not be disposed, lateral grooves and sipes may be disposed as appropriate.

[First Shoulder Land Portion]

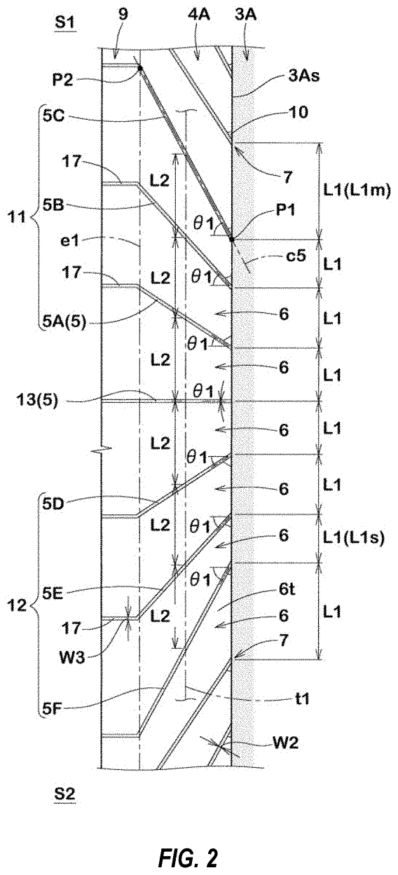

FIG. 2 is a partially enlarged view of the first shoulder land portion 4A. In the present embodiment, the first shoulder land portion 4A can be formed as a straight rib extending linearly in the tire circumferential direction. A plurality of first shoulder groove portions 5 extending from the first shoulder circumferential groove 3A to the first tread ground contact end e1 can be in the first shoulder land portion 4A. Thus, the first shoulder land portion 4A can have a plurality of first shoulder blocks 6 demarcated by the plurality of first shoulder groove portions 5.

[First Shoulder Groove-Like Portion (i.e., Groove Portion)]

In the present embodiment, each of the plurality of first shoulder groove portions 5 is formed as a sipe having a groove width W2 of not greater than 1.0 mm. Thus, in the tire 1 of the present embodiment, wall surfaces, on both sides, of each first shoulder groove portion 5 can support each other during running, which can reduce difference in stiffness, in the front-rear direction, of the first shoulder land portion 4A. Thus, noise performance can be enhanced without degrading uneven wear resistance. The groove width W2 can be not greater than 0.8 mm, for instance, not greater than 0.6 mm. The depth of the first shoulder groove portion 5 can be set to be, for example, 5.0 to 7.0 mm.

In the present embodiment, the first shoulder groove portion 5 can extend linearly from the first shoulder circumferential groove 3A to the first tread ground contact end e1. The first shoulder groove portion 5 may be bent or curved.

Among the plurality of first shoulder groove portions 5, a pair of first shoulder groove portions 5, 5 adjacent to each other in the tire circumferential direction can have different angles θ1 relative to the tire axial direction. In the description herein, when the angle θ1 represents inclination to one side S1 in the tire circumferential direction from the inner side toward the outer side in the tire axial direction, the angle θ1 is specified as indicating a positive value.

In the present embodiment, the angle θ1 is specified on a straight line (in this example, groove center line c5) connecting between a first intersection point P1 of the first shoulder groove portion 5 and the first shoulder circumferential groove 3A and a second intersection point P2 of the first shoulder groove-like portion 5 and the first tread ground contact end e1. The first intersection point P1 is specified as a position at which the groove center line c5 of the first shoulder groove portion 5 and a groove edge 3As of the first shoulder circumferential groove 3A intersect each other. The second intersection point P2 is specified as a position at which the groove center line c5 of the first shoulder groove portion 5 and the first tread ground contact end e1 intersect each other.

The plurality of first shoulder groove portions 5 can include a plurality of different kinds of first shoulder groove portions 5, for instance, that can have different first pitch lengths L1 each representing a pitch length in the tire circumferential direction at a connecting portion 7 to the first shoulder circumferential groove 3A. Thus, the first shoulder land portion 4A can include a plurality of different kinds of first shoulder blocks 6, for instance, having different lengths in the tire circumferential direction on the first shoulder circumferential groove 3A side on which ground contact pressure may be relatively high during running. The connecting portion 7 is specified at the first intersection point P1 described above.

Thus, in the tire 1 of the present embodiment, the pair of first shoulder groove portions 5, 5 adjacent to each other in the tire circumferential direction can have the different angles θ1, and, furthermore, a plurality of different kinds of the first shoulder groove portions 5 having the different first pitch lengths L1 can be disposed. Thus, the angle θ1 of the first shoulder groove portion 5 and ground contact end shapes of the first shoulder block 6 on both sides in the tire circumferential direction can constantly vary in the tire circumferential direction. Therefore, impact sound generated when the first shoulder land portion 4A (first shoulder block 6) comes into contact with the ground can have various loudness including a higher sound and a lower sound during running on a road surface. Therefore, a frequency of pitch sound is dispersed, so that noise performance can be enhanced.

In the present embodiment, the maximum value L1m of the first pitch length L1 can be set to be 1.2 to 1.5 times the average of the first pitch lengths L1, as an example. In a case where the maximum value L1m is set to be not less than 1.2 times the average of the first pitch lengths L1, the plurality of first shoulder groove portions 5 can include a first shoulder groove portion 5 having a great first pitch length L1. Thus, a frequency of pitch sound can be effectively dispersed, so that a density of a power value of sound can be reduced. Thus, noise performance can be enhanced. Meanwhile, in a case where the maximum value L1m is set to be not greater than 1.5 times the average of the first pitch lengths L1, the plurality of first shoulder groove portions 5 can be prevented from including a first shoulder groove portion 5 having the first pitch length L1 that is greater than required. Thus, excessive increase of difference in stiffness, in the front-rear direction, of the first shoulder land portion 4A (first shoulder block 6) can be prevented, so that uneven wear resistance can be maintained. From such a viewpoint, the maximum value L1m can be not less than 1.3 times the average of the first pitch lengths L1, for instance, not greater than 1.4 times the average thereof. The average of the first pitch lengths L1 may be obtained by dividing the sum of all kinds of the first pitch lengths L1 by the number of the kinds.

Meanwhile, the minimum value L1s of the first pitch length L1 can be set to be 0.5 to 0.8 times the average of the first pitch lengths L1. In a case where the minimum value L1s is set to be not greater than 0.8 times the average of the first pitch lengths L1, the plurality of first shoulder groove portions 5 can include a first shoulder groove portion 5 having a small first pitch length L1. Thus, a frequency of pitch sound can be more effectively dispersed, so that a density of a power value of sound can be reduced. Therefore, noise performance can be enhanced. Meanwhile, in a case where the minimum value L1s is set to be not less than 0.5 times the average of the first pitch lengths L1, the plurality of first shoulder groove portions 5 can be prevented from including a first shoulder groove portion 5 having the first pitch length L1 that is less than required. Thus, difference in stiffness, in the front-rear direction, of the first shoulder land portion 4A (first shoulder block 6) can be reduced to be small, so that uneven wear resistance can be maintained. From such a viewpoint, the minimum value L1s can be not less than 0.6 times the average of the first pitch lengths L1, for instance, not greater than 0.7 times the average thereof.

The angles θ1 of the plurality of first shoulder groove portions 5 can be set to be −70° to 70°, for instance. Thus, a range of the angle θ1 that can be taken by each first shoulder groove portion 5 can be increased, so that a frequency of pitch sound can be effectively dispersed. Furthermore, near the connecting portion 7 between the first shoulder groove portion 5 and the first shoulder circumferential groove 3A, the first shoulder land portion 4A can be inhibited from having a portion that is more acute than required, and uneven wear resistance can be maintained. From such a viewpoint, the angle θ1 may be −65° to 65°. In a portion, of the first shoulder land portion 4A, which can be sharpened so as to form an acute angle near the connecting portion 7, a chamfered portion 10 to reduce uneven wear may be formed.

[First Unit]

As shown in FIG. 1, in the first shoulder land portion 4A of the present embodiment, a plurality of first units 8 each formed of a part of the first shoulder groove portions 5 among the plurality of first shoulder groove portions 5 can be aligned in the tire circumferential direction. Thus, in the first shoulder land portion 4A, a pattern in which the plurality of first shoulder groove portions 5 are spaced in the tire circumferential direction can be formed. The number of the first shoulder groove portions 5, the angles θ1 (shown in FIG. 2) thereof, and the first pitch lengths L1 (shown in FIG. 2) thereof may be uniform among the first units 8 or may be different among the first units 8.

As shown in FIG. 1 and FIG. 2, in the present embodiment, the first unit 8 can be formed of a first portion 11 in which the first shoulder groove portions 5 that have the angles θ1 (shown in FIG. 2) indicating positive values can be continuously disposed, and a second portion 12 in which the first shoulder groove portions 5 that have the angles θ1 indicating negative values can be continuously disposed.

In order to effectively exhibit the effect, the angle θ1 of the first shoulder groove portions 5 of each of the first portion 11 and the second portion 12 can vary continuously in the tire circumferential direction between the angle maximum value and the angle minimum value (for example, −70° to 70°). Thus, in the first unit 8 (first shoulder land portion 4A), pitch sounds having different frequencies can be continuously generated, so that noise performance can be enhanced. In the present embodiment, although the first portion 11 can be on the one side S1 in the tire circumferential direction relative to the second portion 12, the first portion 11 may be disposed on the other side S2 in the tire circumferential direction relative to the second portion 12.

[First Portion]

In the first portion 11, the first shoulder groove portions 5 that have the angles θ1 indicating positive values can be spaced in the tire circumferential direction (that is, inclined to the one side S1 in the tire circumferential direction from the inner side toward the outer side in the tire axial direction). As shown in FIG. 2, in the present embodiment, the first portion 11 can include three kinds of the first shoulder groove portions 5 (first groove portion 5A, second groove portion 5B, and third groove portion 5C) having different angles θ1. However, the present disclosure is not limited thereto, and the first potion 11 may include, for example, two kinds of the first shoulder groove portions 5 or four or more kinds of the first shoulder groove portions 5.

As shown in FIG. 2, in the present embodiment, the first groove portion 5A can be the first shoulder groove portion 5 that has the angle θ1 indicating the smallest value in the first portion 11. The third groove portion 5C can be the first shoulder portion 5 that has the angle θ1 indicating the greatest value in the first portion 11. The second groove portion 5B can be the first shoulder groove portion 5 having the angle θ1 that is greater than the angle θ1 of the first groove portion 5A and less than the angle θ1 of the third groove portion 5C.

As shown in FIG. 1, in the first portion 11 of the present embodiment, the first groove portion 5A, the second groove portion 5B, and the third groove portion 5C can be sequentially disposed from the one side S1 toward the other side S2 in the tire circumferential direction. Thus, in the first portion 11, the angle θ1 (shown in FIG. 2) of the first shoulder groove portion 5 can be gradually increased from the one side S1 toward the other side S2 in the tire circumferential direction. In the first portion 11 having such a structure, a frequency of pitch sound can be effectively dispersed and noise performance is enhanced. Furthermore, change of stiffness, in the front-rear direction, of the first shoulder land portion 4A (first shoulder block 6) can become gentle and uneven wear resistance can be maintained.

As shown in FIG. 1 and FIG. 2, in the first portion 11 of the present embodiment, the first groove portion 5A, the second groove portion 5B, and the third groove portion 5C can be sequentially disposed from the other side S2 toward the one side S1 in the tire circumferential direction. Thus, in the first portion 11, the angle θ1 of the first shoulder groove portion 5 can be gradually increased from the other side S2 toward the one side S1 in the tire circumferential direction, whereby noise performance can be enhanced without degrading uneven wear resistance.

As shown in FIG. 1, in the first portion 11, the second groove portion 5B can be between the paired third groove portions 5C and 5C adjacent to each other in the tire circumferential direction. Thus, in the first portion 11, change of stiffness in the front-rear direction can become gentle, and uneven wear resistance can be maintained.

[Second Portion]

As shown in FIG. 1 and FIG. 2, in the second portion 12, the first shoulder groove portions 5 that have the angles θ1 indicating negative values can be spaced in the tire circumferential direction (that is, inclined to the other side S2 in the tire circumferential direction from the inner side toward the outer side in the tire axial direction) In the present embodiment, the second portion 12 can include three kinds of the first shoulder groove portions 5 (fourth groove portion 5D, fifth groove portion 5E, and sixth groove portion 5F) having different angles θ1. However, the present disclosure is not limited thereto, and the second portion 12 may include, for example, two kinds of the first shoulder groove portions 5 or four or more kinds of the first shoulder groove portions 5.

As shown in FIG. 2, in the present embodiment, the fourth groove portion 5D can be the first shoulder groove portion 5 that has the angle θ1 indicating the greatest value in the second portion 12 in which the angle θ1 indicates a negative value. The sixth groove portion 5F can be the first shoulder groove portion 5 that has the angle θ1 indicating the smallest value in the second portion 12. The fifth groove portion 5E can be the first shoulder groove portion 5 having the angle θ1 that is less than the angle θ1 of the fourth groove portion 5D and greater than the angle θ1 of the sixth groove portion 5F.

As shown in FIG. 1, in the second portion 12 of the present embodiment, the fourth groove portion 5D, the fifth groove portion 5E, and the sixth groove portion 5F can be sequentially disposed from the one side S1 toward the other side S2 in the tire circumferential direction. Thus, in the second portion 12, the angle θ1 of the first shoulder groove portion 5 can be gradually reduced from the one side S1 toward the other side S2 in the tire circumferential direction. In the second portion 12 having such a structure, a frequency of pitch sound can be effectively dispersed, and noise performance can be enhanced. Furthermore, change of stiffness, in the front-rear direction, of the first shoulder land portion 4A (first shoulder block 6) can become gentle, and uneven wear resistance can be maintained.

As shown in FIG. 1 and FIG. 2, in the second portion 12 of the present embodiment, the fourth groove portion 5D, the fifth groove portion 5E, and the sixth groove portion 5F can be sequentially disposed from the other side S2 toward the one side S1 in the tire circumferential direction. Thus, in the second portion 12, the angle θ1 of the first shoulder groove portion 5 can be gradually increased from the other side S2 toward the one side S1 in the tire circumferential direction, whereby noise performance can be enhanced without degrading uneven wear resistance.

In FIG. 1, in the second portion 12, the fifth groove portion 5E can be between the paired sixth groove portions 5F and 5F adjacent to each other in the tire circumferential direction. Thus, in the second portion 12, change of stiffness in the front-rear direction can become gentle, and uneven wear resistance can be maintained.

[Third Portion]

As shown in FIG. 2, in the present embodiment, the first unit 8 can further include a third portion 13 that can include the first shoulder groove portion 5 that has the angle θ1 indicating zero. In the third portion 13 having such a structure, pitch sound having a frequency different from those in the first portion 11 and the second portion 12 can be generated, so that noise performance can be enhanced. In the present embodiment, although the third portion 13 can be formed of one first shoulder groove portion 5, the third portion 13 may be formed of two or more first shoulder groove portions 5.

In the present embodiment, the third portion 13 can be between the first portion 11 and the second portion 12. Thus, in the first unit 8, the third groove portion 5C, the second groove portion 5B, the first groove portion 5A, the third portion 13, the fourth groove portion 5D, the fifth groove portion 5E, and the sixth groove portion 5F can be sequentially disposed from the one side S1 toward the other side S2 in the tire circumferential direction. Thus, in the present embodiment, the angle θ1 (shown in FIG. 2) of the first shoulder groove portion 5 can be continuously changed (gradually reduced) from the one side S1 toward the other side S2 in the tire circumferential direction, and a frequency of pitch sound can be effectively dispersed, and noise performance can be enhanced. Furthermore, change of stiffness, in the front-rear direction, of the first shoulder land portion 4A (first shoulder block 6) can become gentle, and uneven wear resistance can be maintained.

As shown in FIG. 1, the third portion 13 (first shoulder groove portion 5 at which the angle θ1 indicates zero) of the present embodiment can be disposed on the one side S1 in the tire circumferential direction relative to the first groove portion 5A (first shoulder groove portion 5 that has the angle θ1 indicating the smallest value) of the first portion 11. Thus, in the first unit 8, change of stiffness, in the front-rear direction, of the first shoulder land portion 4A (first shoulder block 6) can become gentle, and uneven wear resistance can be maintained.

[Protruding Portion]

As shown in FIG. 2, in the present embodiment, the plurality of first shoulder groove portions 5 each can include a protruding portion 17 extending outwardly from the first tread ground contact end e1 in the tire axial direction. In the present embodiment, the protruding portion 17 may also be formed as a sipe having the maximum groove width W3 of not greater than 1.0 mm, for instance. Thus, in the tire 1 of the present embodiment, stiffness in the tire circumferential direction can be maintained at a buttress portion 9 that comes into contact with the ground during cornering, and steering sound can be inhibited from becoming worse. Thus, in the tire 1 of the present embodiment, noise performance (steering noise performance) can be enhanced.

[First Shoulder Block]

The first shoulder blocks 6 of the present embodiment can be demarcated by the first shoulder circumferential groove 3A, the first tread ground contact end e1, and the plurality of first shoulder groove portions 5, and each form a trapezoidal tread surface 6t.

At the center position t1, in the tire axial direction, of the first shoulder land portion 4A, a second pitch length L2 that is a pitch length, in the tire circumferential direction, for the plurality of first shoulder groove portions 5 can be substantially constant. In the description herein, “substantially constant” cam mean that the second pitch length L2 is constant in consideration of, for example, a molding error generated when the tire 1 is obtained by vulcanization-molding in a mold. Therefore, in a case where a ratio obtained by dividing the smallest second pitch length L2 by the greatest second pitch length L2 is in a range of 0.95 to 1.00, the second pitch length L2 may be considered to be substantially constant. The second pitch length L2 can be specified at an intersection point of the center position t1 and the groove center line c5 of the first shoulder groove portion 5.

Thus, in the present embodiment, the second pitch length L2 can be set to be substantially constant, whereby difference in stiffness, in the front-rear direction, of each first shoulder block 6 can be reduced while the first pitch lengths L1 can be made different. Thus, uneven wear resistance can be maintained.

In order to effectively exhibit the effect, an area of the tread surface 6t of the first shoulder block 6 can be set to be substantially equal among the plurality of first shoulder blocks 6, for instance. Thus, the rubber volume can become almost uniform among the first shoulder blocks 6, and difference in stiffness, in the front-rear direction, of the first shoulder land portion 4A can be reduced, so that uneven wear resistance can be maintained. In the description herein, “substantially equal” can mean that the area is equal in consideration of, for example, a molding error generated when the tire 1 is obtained by vulcanization-molding in a mold. Therefore, in a case where a ratio obtained by dividing the smallest value of an area of the tread surface 6t by the greatest value of an area of the tread surface 6t, among the tread surfaces 6t of all the first shoulder blocks 6, is in a range of 0.95 to 1.00, the areas of the tread surfaces 6t may be considered to be substantially equal to each other.

[Second Shoulder Land Portion]

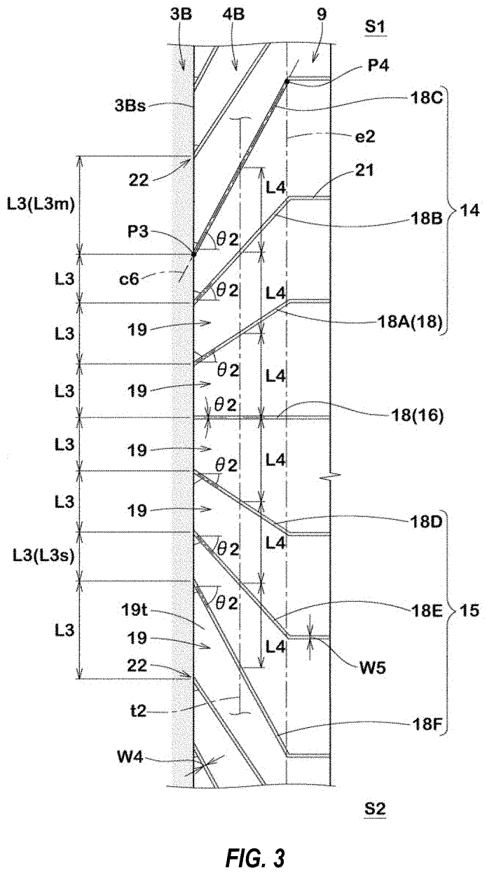

FIG. 3 is a partially enlarged view of the second shoulder land portion 4B in FIG. 1. In the present embodiment, the second shoulder land portion 4B can be formed as a straight rib extending linearly in the tire circumferential direction. A plurality of second shoulder groove portions 18 extending from the second shoulder circumferential groove 3B to the second tread ground contact end e2 can be in the second shoulder land portion 4B. Thus, the second shoulder land portion 4B can have a plurality of second shoulder blocks 19 demarcated by the plurality of second shoulder groove portions 18.

[Second Shoulder Groove-Like Portion (i.e., Groove Portion)]

In the present embodiment, each of the plurality of second shoulder (i.e., groove portion) portions 18 can be formed as a sipe having a groove width W4 of not greater than 1.0 mm, for instance, similar to the first shoulder groove portion 5. Thus, uneven wear resistance can be maintained. In the present embodiment, although the second shoulder groove portion 18 can extend linearly from the second shoulder circumferential groove 3B to the second tread ground contact end e2, the second shoulder groove portion 18 may be bent or curved.

Among the plurality of second shoulder groove portions 18, a pair of second shoulder groove portions 18, 18 adjacent to each other in the tire circumferential direction can have different angles θ2 relative to the tire axial direction. In the description herein, when the angle θ2 represents inclination to the one side 51 in the tire circumferential direction from the inner side toward the outer side in the tire axial direction, the angle θ2 is specified as indicating a positive value.

In the present embodiment, the angle θ2 can be specified on a straight line (in this example, groove center line c6) connecting between a third intersection point P3 of the second shoulder groove portion 18 and the second shoulder circumferential groove 3B, and a fourth intersection point P4 of the second shoulder groove portion 18 and the second tread ground contact end e2. The third intersection point P3 is specified as an intersection point of the groove center line c6 of the second shoulder groove portion 18 and a groove edge 3Bs of the second shoulder circumferential groove 3B. The fourth intersection point P4 can be specified as an intersection point of the groove center line c6 of the second shoulder groove portion 18 and the second tread ground contact end e2.

The plurality of second shoulder groove portions 18 can include a plurality of different kinds of second shoulder groove portions 18 that can have different third pitch lengths L3 each representing a pitch length in the tire circumferential direction at a connecting portion 22 to the second shoulder circumferential groove 3B. Thus, the second shoulder land portion 4B can include a plurality of kinds of second shoulder blocks 19 having different lengths in the tire circumferential direction on the second shoulder circumferential groove 3B side on which ground contact pressure may be relatively high during running. The connecting portion 22 can be specified at the third intersection point P3 described above.

Thus, in the tire 1 of the present embodiment, the pair of second shoulder groove portions 18, 18 adjacent to each other in the tire circumferential direction can have the different angles θ2, and, furthermore, a plurality of different kinds of the second shoulder groove portions 18 having the different third pitch lengths L3 can be disposed. Thus, impact sound generated when the second shoulder land portion 4B (second shoulder block 19) comes into contact with the ground can have various loudness including a higher sound and a lower sound during running on a road surface. Therefore, a frequency of pitch sound can be dispersed, so that noise performance can be enhanced.

In the present embodiment, from the same viewpoint as for the above-described first pitch length L1 (shown in FIG. 2), the maximum value L3m of the third pitch length L3 can be set to be 1.2 to 1.5 times (e.g., 1.3 to 1.4 times) the average of the third pitch lengths L3. Furthermore, the minimum value L3s of the third pitch length L3 can be set to be 0.5 to 0.8 times (e.g., 0.6 to 0.7 times) the average of the third pitch lengths L3.

The angles θ2 of the plurality of the second shoulder groove portions 18 can be set to be −70° to 70° (e.g., −65° to 65°) from the same viewpoint as for the angles θ1 (shown in FIG. 2) of the first shoulder groove portions 5 as described above.

As shown in FIG. 1, in the present embodiment, the second shoulder groove portion 18 can be inclined in the same direction as the first shoulder groove portion 5 closest to the second shoulder groove portion 18 in the tire circumferential direction. In the description herein, “closest in the tire circumferential direction” can mean that a distance in the tire circumferential direction over which the second shoulder groove portion 18 at the third intersection point P3 (shown in FIG. 3) and the first shoulder groove portion 5 at the first intersection point P1 (shown in FIG. 2) are distant from each other, can be the smallest.

In the present embodiment, although all of the second shoulder groove portions 18 and the first shoulder groove portions 5 adjacent thereto can be inclined in the same direction, the present disclosure is not limited thereto. For example, a part of the second shoulder groove portions 18 and the first shoulder groove portions 5 adjacent thereto may be inclined in the same direction.

In the present embodiment, the second shoulder groove portion 18 (for example, seventh groove portion 18A) that has the angle θ2 (shown in FIG. 3) indicating a positive value and the first shoulder groove portion 5 (for example, the first groove portion 5A) that has the angle θ1 (shown in FIG. 2) indicating a positive value can be closest to each other in the tire circumferential direction. Similarly, the second shoulder groove portion 18 (for example, tenth groove portion 18D) that has the angle θ2 indicating a negative value and the first shoulder groove portion 5 (for example, fourth groove portion 5D) that has the angle θ1 indicating a negative value can be closest to each other in the tire circumferential direction. In the present embodiment, the second shoulder groove portion 18 that has the angle θ2 indicating zero and the first shoulder groove portion 5 that has the angle θ1 indicating zero can be closest to each other in the tire circumferential direction.

Thus, in the present embodiment, the first shoulder groove portion 5 and the second shoulder groove portion 18 closest to each other in the tire circumferential direction can be inclined in the same direction, so that difference between stiffness, in the front-rear direction, of the first shoulder land portion 4A and stiffness, in the front-rear direction, of the second shoulder land portion 4B can be reduced to be small. Thus, uneven wear resistance can be maintained.

In order to effectively maintain uneven wear resistance, the angle θ1 (shown in FIG. 2) and the angle θ2 (shown in FIG. 3) of the first shoulder groove portion 5 and the second shoulder groove portion 18, respectively, closest to each other may be set to be substantially equal to each other. Thus, difference between stiffness, in the front-rear direction, of the first shoulder land portion 4A and stiffness, in the front-rear direction, of the second shoulder land portion 4B can be further reduced to be small, and uneven wear resistance can be maintained. “Substantially equal to each other” can mean that the angle θ1 and the angle θ2 are equal to each other in consideration of, for example, the above-described molding error, and, in a case where a ratio θ1/θ2 between the angles is in a range of 0.95 to 1.05, the angle θ1 and the angle θ2 may be considered to be substantially equal to each other.

The first pitch length L1 (shown in FIG. 2) and the third pitch length L3 (shown in FIG. 3) of the first shoulder groove portion 5 and the second shoulder groove portion 18, respectively, closest to each other may be set to be substantially equal to each other. Thus, the areas of the tread surfaces of the first shoulder block 6 and the second shoulder block 19 adjacent to each other in the tire axial direction can be made almost equal to each other. Therefore, difference between stiffness, in the front-rear direction, of the first shoulder land portion 4A and stiffness, in the front-rear direction, of the second shoulder land portion 4B can be further reduced to be small, and uneven wear resistance can be maintained. “Substantially equal to each other” can mean that the first pitch length L1 and the third pitch length L3 may be considered to be substantially equal to each other in a case where a ratio L1/L3 between the pitch lengths is in a range of 0.95 to 1.05.

[Second Unit]

As shown in FIG. 1, in the second shoulder land portion 4B of the present embodiment, a plurality of second units 20 each formed of a part of the second shoulder groove portions 18 among the plurality of second shoulder groove portions 18 can be aligned in the tire circumferential direction. Thus, in the second shoulder land portion 4B, a pattern in which the plurality of second shoulder groove portions 18 are spaced in the tire circumferential direction can be formed. The number of the second shoulder groove portions 18, the angles θ2 (shown in FIG. 3) thereof, and the third pitch lengths L3 (shown in FIG. 3) thereof may be uniform among the second units 20 or may be different among the second units 20.

As shown in FIG. 1 and FIG. 3, the second unit 20 can be formed of a fourth portion 14 in which the second shoulder groove portions 18 that have the angles θ2 (shown in FIG. 3) indicating positive values can be continuously disposed, and a fifth portion 15 in which the second shoulder groove portions that have the angles θ2 indicating negative values can be continuously disposed. Thus, in the second unit 20, a frequency of pitch sound can be different between the fourth portion 14 and the fifth portion 15, and noise performance can be enhanced. In order to effectively exhibit such an effect, the angle θ2 of the second shoulder groove portion 18 of each of the fourth portion 14 and the fifth portion 15 can vary continuously between the angle maximum value and the angle minimum value (for example, −70° to 70°).

[Fourth Portion]

In the fourth portion 14, the second shoulder groove portions 18 that have the angles θ2 indicating positive values can be spaced in the tire circumferential direction (that is, inclined to the one side S1 in the tire circumferential direction from the inner side toward the outer side in the tire axial direction). As shown in FIG. 3, in the present embodiment, the fourth portion 14 can include three different kinds of the second shoulder groove portions 18 (seventh groove portion 18A, eighth groove portion 18B, and ninth groove portion 18C) that may have different angles θ2. However, the present disclosure is not limited thereto.

As shown in FIG. 3, in the present embodiment, the seventh groove portion 18A can be the second shoulder groove portion 18 that has the angle θ2 indicating the smallest value in the fourth portion 14. The ninth groove portion 18C can be the second shoulder groove portion 18 that has the angle θ2 indicating the greatest value in the fourth portion 14. The eighth groove portion 18B can be the second shoulder groove portion 18 having the angle θ2 that is greater than the angle θ2 of the seventh groove portion 18A and less than the angle θ2 of the ninth groove portion 18C.

As shown in FIG. 1, in the fourth portion 14 of the present embodiment, the seventh groove portion 18A, the eighth groove portion 18B, and the ninth groove portion 18C can be sequentially disposed from the one side S1 toward the other side S2 in the tire circumferential direction. Furthermore, in the fourth portion 14, the seventh groove portion 18A, the eighth groove portion 18B, and the ninth groove portion 18C can be sequentially disposed from the other side S2 toward the one side S1 in the tire circumferential direction. Thus, in the fourth portion 14, while the angle θ2 of the second shoulder groove portion 18 can be gradually increased from the one side S1 toward the other side S2 in the tire circumferential direction, the angle θ2 can be gradually increased from the other side S2 toward the one side S1. Therefore, in the present embodiment, noise performance can be enhanced without degrading uneven wear resistance. In the fourth portion 14, the eighth groove portion 18B can be between the paired ninth groove portions 18C and 18C adjacent to each other in the tire circumferential direction, whereby change of stiffness in the front-rear direction can become gentle, and uneven wear resistance can be maintained.

[Fifth Portion]

As shown in FIG. 1 and FIG. 3, in the fifth portion 15, the second shoulder groove portions 18 that can have the angles θ2 indicating negative values can be spaced in the tire circumferential direction (that is, inclined to the other side S2 in the tire circumferential direction from the inner side toward the outer side in the tire axial direction). In the present embodiment, the fifth portion 15 can include three different kinds of the second shoulder groove portions 18 (tenth groove portion 18D, eleventh groove portion 18E, and twelfth groove portion 18F) which can have different angles θ2. However, the present disclosure is not limited thereto.

As shown in FIG. 3, in the present embodiment, the tenth groove portion 18D can be the second shoulder groove portion 18 that has the angle θ2 indicating the greatest value in the fifth portion 15. The twelfth groove portion 18F can be the second shoulder groove portion 18 that has the angle θ2 indicating the smallest value in the fifth portion 15. The eleventh groove portion 18E can be the second shoulder groove portion 18 having the angle θ2 that is less than the angle θ2 of the tenth groove portion 18D and greater than the angle θ2 of the twelfth groove portion 18F.

As shown in FIG. 1, in the fifth portion 15 of the present embodiment, the tenth groove portion 18D, the eleventh groove portion 18E, and the twelfth groove portion 18F can be sequentially disposed from the one side S1 toward the other side S2 in the tire circumferential direction. Furthermore, in the fifth portion 15, the tenth groove portion 18D, the eleventh groove portion 18E, and the twelfth groove portion 18F can be sequentially disposed from the other side S2 toward the one side S1 in the tire circumferential direction. Thus, in the fifth portion 15, while the angle θ2 of the second shoulder groove portion 18 can be gradually reduced from the one side S1 toward the other side S2 in the tire circumferential direction, the angle θ2 can be gradually reduced from the other side S2 toward the one side S1. Therefore, in the present embodiment, noise performance can be enhanced without degrading uneven wear resistance. In the fifth portion 15, the eleventh groove portion 18E can be between the paired twelfth groove portions 18F and 18F adjacent to each other in the tire circumferential direction, so that change of stiffness in the front-rear direction can become gentle, and uneven wear resistance can be maintained.

[Sixth Portion]

As shown in FIG. 3, in the present embodiment, the second unit 20 can further include a sixth portion 16 that can include the second shoulder groove portion 18 that can have the angle θ2 indicating zero. Therefore, pitch sound having a frequency different from those in the fourth portion 14 and the fifth portion 15 can be generated, so that noise performance can be enhanced. In the present embodiment, although the sixth portion 16 is formed of one second shoulder groove portion 18, the sixth portion 16 may instead be formed of two or more second shoulder groove portions 18.

In the present embodiment, the sixth portion 16 can be between the fourth portion 14 and the fifth portion 15. Thus, the ninth groove portion 18C, the eighth groove portion 18B, the seventh groove portion 18A, the sixth portion 16, the tenth groove portion 18D, the eleventh groove portion 18E, and the twelfth groove portion 18F can be sequentially disposed from the one side S1 toward the other side S2 in the tire circumferential direction. Thus, in the present embodiment, the angle θ2 of the second shoulder groove portion 18 can be continuously changed (gradually reduced) from the one side S1 toward the other side S2 in the tire circumferential direction, and a frequency of pitch sound can be effectively dispersed. Therefore, noise performance can be enhanced. Furthermore, change of stiffness, in the front-rear direction, of the second shoulder land portion 4B (second shoulder block 19) can become gentle, and uneven wear resistance can be maintained.

As shown in FIG. 1, in the present embodiment, the sixth portion 16 (second shoulder groove portion 18 that can have the angle θ2 indicating zero) can be on the one side S1 in the tire circumferential direction relative to the seventh groove portion 18A (second shoulder groove portion 18 that can have the angle θ2 indicating the smallest value) of the fourth portion 14. Thus, in the second unit 20, change of stiffness, in the front-rear direction, of the second shoulder land portion 4B (second shoulder block 19) can become gentle, and uneven wear resistance can be maintained.

[Protruding Portion]

As shown in FIG. 3, in the present embodiment, the plurality of second shoulder groove portions 18 each can include a protruding portion 21 extending outwardly from the second tread ground contact end e2 in the tire axial direction. In the present embodiment, the protruding portion 21 may also be formed as a sipe having the maximum groove width W5 of not greater than 1.0 mm, for instance, so that increase of steering sound can be inhibited, and noise performance can be enhanced.

[Second Shoulder Block]

The second shoulder blocks 19 of the present embodiment can be demarcated by the second shoulder circumferential groove 3B, the second tread ground contact end e2, and the plurality of the second shoulder groove portions 18, and each form a trapezoidal tread surface 19t.

At the center position t2, in the tire axial direction, of the second shoulder land portion 4B, a fourth pitch length L4 that may be a pitch length, in the tire circumferential direction, for the plurality of second shoulder groove portions 18 can be substantially constant. Thus, difference in stiffness, in the front-rear direction, of the second shoulder land portion 4B (second shoulder block 19) can be reduced while the third pitch lengths L3 can be different, so that uneven wear resistance can be maintained. The fourth pitch length L4 can be specified at the intersection point of the center position t2 and the groove center line c6 of the second shoulder groove portion 18.

An area of the tread surface 19t of the second shoulder block 19 can be set to be substantially equal among the plurality of second shoulder blocks 19. Thus, stiffness can be almost uniform among the second shoulder blocks 19, and, therefore, difference in stiffness, in the front-rear direction, of the second shoulder land portion 4B can be reduced, so that uneven wear resistance can be maintained.

### Tire (Second Embodiment)

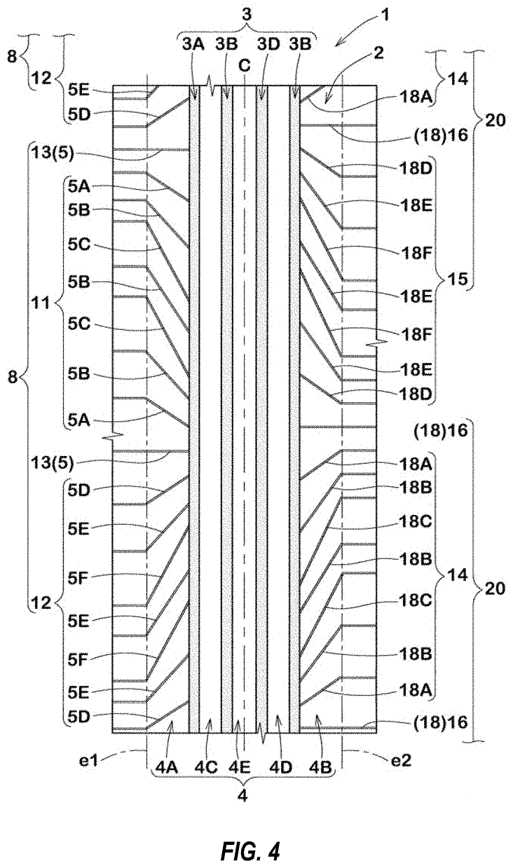

FIG. 4 is a development of the tread portion 2 of the tire 1 according to another embodiment of the present disclosure. In the present embodiment, the same components as those of the above-described embodiments are denoted by the same reference characters, and the description thereof may be omitted.

In the present embodiment, the second shoulder groove portion 18 and the first shoulder groove portion 5 closest thereto in the tire circumferential direction can be inclined in opposite directions. In the present embodiment, a part of the second shoulder groove portions 18 among all of the second shoulder groove portions 18 and the first shoulder groove portions 5 adjacent thereto can be inclined in opposite directions. However, the present disclosure is not limited thereto. For example, all of the second shoulder groove portions 18 and the first shoulder groove portions 5 adjacent thereto may be inclined in opposite directions.

In the present embodiment, the second shoulder groove portion 18 (for example, the seventh groove portion 18A) that can have the angle θ2 (shown in FIG. 3) indicating a positive value and the first shoulder groove portion 5 (for example, the fourth groove portion 5D) that can have the angle θ1 (shown in FIG. 2) indicating a negative value can be closest to each other in the tire circumferential direction. Similarly, the second shoulder groove portion 18 (for example, the twelfth groove portion 18F) that can have the angle θ2 indicating a negative value and the first shoulder groove portion 5 (for example, the first groove portion 5A) that can have the angle θ1 indicating a positive value can be closest to each other in the tire circumferential direction.

Thus, in the present embodiment, the second shoulder groove portion 18 and the first shoulder groove portion 5 closest thereto in the tire circumferential direction can be inclined in opposite directions, for instance, so that pitch sounds having different frequencies can be generated in the first shoulder land portion 4A and the second shoulder land portion 4B. Thus, noise performance can be enhanced.

### Tire (Third Embodiment)

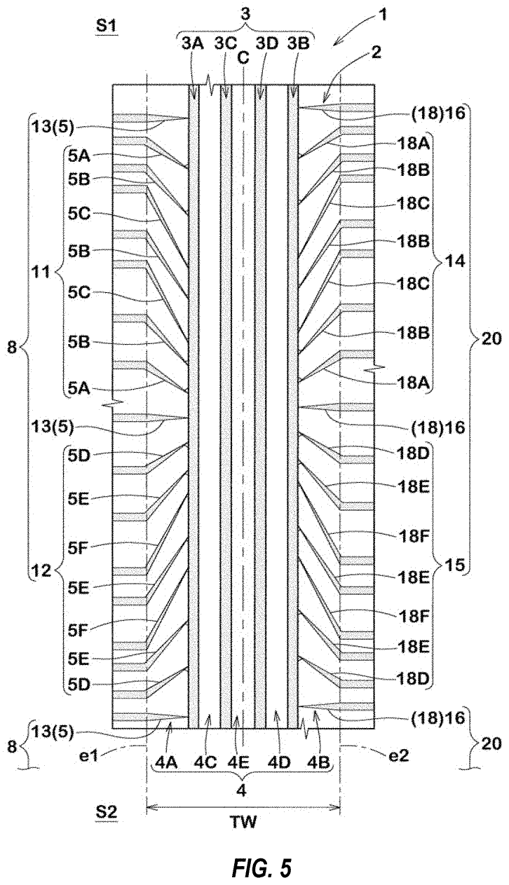

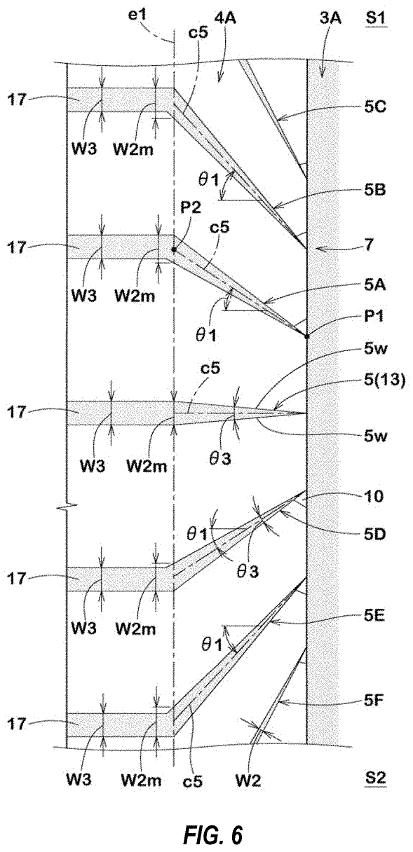

FIG. 5 is a development of the tread portion 2 of the tire 1 according to still another embodiment of the present disclosure. FIG. 6 is a partially enlarged view of the first shoulder land portion 4A in FIG. 5. In the present embodiment, the same components as those of the above-described embodiments are denoted by the same reference characters, and the description thereof may be omitted.

### First Shoulder Groove-Like Portion (i.e., Groove Portion) (Third Embodiment)

In the present embodiment, each of the plurality of first shoulder groove portions 5 can be formed as a lateral groove in which the groove width W2 (maximum groove width W2m) shown in FIG. 6 can be greater than 1.0 mm, for instance. The first shoulder groove portion 5 having such a structure can allow water on a road surface to be discharged at the first shoulder land portion 4A during running on a wet road surface and can allow resistance to hydroplaning to be enhanced. In order to effectively exhibit such an effect, the maximum value (maximum groove width W2m) of the groove width W2 can be set to be 2.0% to 5.0% of the tread width TW (shown in FIG. 5), for instance.

In the present embodiment, the groove width W2 can be gradually increased from the first shoulder circumferential groove 3A toward the first tread ground contact end e1. Thus, the first shoulder groove portion 5 can be formed in a wedge shape projecting inwardly in the tire axial direction. In the first shoulder groove portion 5 having such a structure, a groove volume can be set to be relatively small on the inner side in the tire axial direction on which ground contact pressure may tend to become relatively high at the first shoulder land portion 4A and coming-in and going-out of air tend to be relatively increased when the tire is in contact with the ground. Thus, air pumping sound can be lowered at the first shoulder groove portion 5, and noise performance can be enhanced. Therefore, in the present embodiment, noise performance can be effectively enhanced through an effect of dispersing a frequency of pitch sound and an effect of lowering air pumping sound. Meanwhile, a groove volume can be set to be relatively great on the outer side (first tread ground contact end e1 side) in the tire axial direction on which the influences of air pumping sound is small, whereby resistance to hydroplaning can be enhanced.

In the first shoulder groove portion 5 that has the angle θ1 indicating a great value, the length along the groove center line c5 can be increased as compared with the first shoulder groove portion 5 that has the angle θ1 indicating a small value. For example, in a case where the groove volume is set to be equal among the first shoulder groove portions 5, the groove width W2 of the first shoulder groove portion 5 (for example, the second groove portion 5B) that has the angle θ1 indicating a great value can become less than the groove width W2 of the first shoulder groove portion 5 (for example, the first groove portion 5A) that has the angle θ1 indicating a small value. Therefore, drainage efficiency may not be maintained.

In order to enhance drainage efficiency, in the present embodiment, the plurality of first shoulder groove portions 5 can be set to have a groove volume increased in proportion to the angle θ1. As in the present embodiment, in a case where the first shoulder groove portion 5 that has the angle θ1 indicating a positive value and the first shoulder groove portion 5 that has the angle θ1 indicating a negative value are included, the groove volume can be set to be increased in proportion to the absolute value of the angle θ1. In the present embodiment, the first shoulder groove portion 5 of the third portion 13 at which the angle θ1 indicates zero can be set to have the smallest groove volume. Meanwhile, the third groove portion 5C and the sixth groove portion 5F having the greatest absolute values of the angle θ1 can each be set to have the greatest groove volume.

Thus, in the present embodiment, the groove width W2 of the first shoulder groove portion 5 that has the angle θ1 (in this example, the absolute value of the angle θ1) indicating a great value can be inhibited from being reduced, and resistance to hydroplaning can be maintained. In the present embodiment, the maximum groove width W2m can be set to be increased in proportion to the absolute value of the angle θ1.

The maximum groove width W3 of the protruding portion 17 can be set as appropriate. In each of the first shoulder groove portions 5, if the maximum groove width W3 and the groove width W2 (maximum groove width W2m) at the first tread ground contact end e1 are set to be equal to each other, the maximum groove width W3 can become greater than required in the first shoulder groove portion 5 that has the angle θ1 (absolute value of the angle θ1) indicating a great value. Thus, steering sound may become worse during cornering. Therefore, the maximum groove width W3 of the protruding portion 17 may be less than the maximum groove width W2m. Thus, in the first shoulder groove portion 5, steering sound can be inhibited from becoming worse during cornering, without reducing a groove volume from the first shoulder circumferential groove 3A to the first tread ground contact end e1.

In order to effectively inhibit steering sound from becoming worse, the maximum groove width W3 of the protruding portion 17 can be set to be not greater than 7.0 mm, for instance. Thus, the maximum groove width W3 can be inhibited from becoming greater than required, and steering sound can be reduced during cornering. In order to effectively exhibit such an effect, the maximum groove width W3 can be set to be not greater than 6.4 mm, for instance.

Although the first shoulder land portion 4A may include a plurality of different kinds of the protruding portions 17 having different maximum groove widths W3, it can be that the maximum groove widths W3 of all of the protruding portions 17 are substantially equal to each other, for instance, in order to prevent steering sound from becoming worse. Thus, steering sound can be effectively inhibited from becoming worse during cornering. “Substantially equal to each other” can mean that the maximum groove widths W3 are equal to each other in consideration of, for example, a molding error as described above. In the present embodiment, the maximum groove width W3 can be made equal to the maximum groove width W2m (in this example, the first shoulder groove portion 5 of the third portion 13 at which the angle θ1 indicates zero) having the smallest value among the maximum groove widths W2m of all of the first shoulder groove portions 5.

An angle θ3 between paired groove walls 5w and 5w of the first shoulder groove portion 5 can be set as appropriate. If the angle θ3 is small, drainage efficiency may not be maintained on the connecting portion 7 side (inner side in the tire axial direction). Meanwhile, if the angle θ3 is great, the maximum groove width W2m of the first shoulder groove portion 5 may become greater than required. Thus, deviation between the maximum groove width W2m and the maximum groove width W3 of the protruding portion 17 can be increased, for instance, so that risk of making steering sound worse may be increased. From such a viewpoint, the angle θ3 can be 2° to 15° (e.g., 3° to 11°).

### Second Shoulder Groove-Like Portion (i.e., Groove Portion) (Third Embodiment)

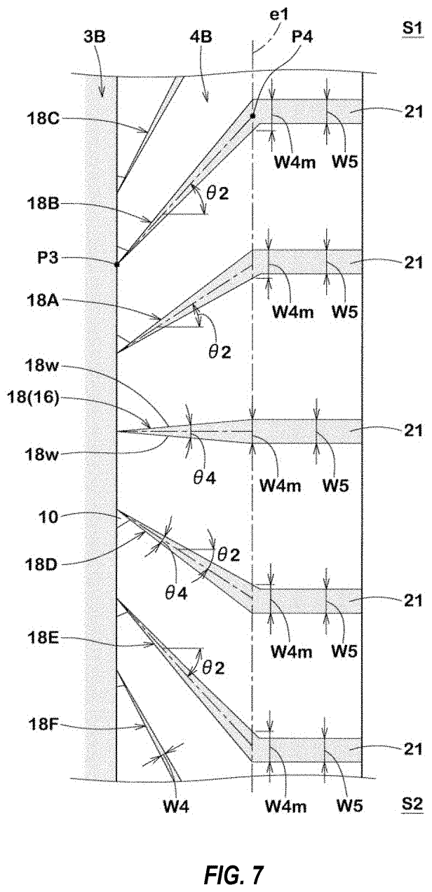

FIG. 7 is a partially enlarged view of the second shoulder land portion 4B in FIG. 5. In the present embodiment, each of the plurality of second shoulder groove portions 18 can be formed as a lateral groove in which a groove width W4 (maximum groove width W4m) can be greater than 1.0 mm, for instance. In the present embodiment, the groove width W4 can be specified as an average of groove widths in a portion from the second shoulder circumferential groove 3B (third intersection point P3) to the second tread ground contact end e2 (fourth intersection point P4). The second shoulder groove portion 18 having such a structure can allow water on a road surface to be discharged at the second shoulder land portion 4B during running on a wet road surface, and can allow resistance to hydroplaning to be enhanced.

In the present embodiment, the groove width W4 can be gradually increased from the second shoulder circumferential groove 3B toward the second tread ground contact end e2. Thus, the second shoulder groove portion 18 can be formed in a wedge shape projecting inwardly in the tire axial direction, similarly to the first shoulder groove portion 5, whereby noise performance and resistance to hydroplaning can be enhanced.

In the present embodiment, the plurality of second shoulder groove portions 18 can be set to have a groove volume increased in proportion to the angle θ2, similarly to the first shoulder groove portion 5 (shown in FIG. 6). Thus, in the present embodiment, the groove width W4 of the second shoulder groove portion 18 that has the angle θ2 (in this example, absolute value of the angle θ2) indicating a great value can be inhibited from being reduced, and resistance to hydroplaning can be maintained.

The maximum groove width W5 of the protruding portion 21 can be less than the maximum groove width W4m of the second shoulder groove portion 18. Thus, in the second shoulder groove portion 18, steering sound can be inhibited from becoming worse during cornering, without reducing a groove volume from the second shoulder circumferential groove 3B to the second tread ground contact end e2. The maximum groove width W5 of the protruding portion 21 can be set to be in the same range as that for the maximum groove width W3 (shown in FIG. 6) of the protruding portion 17 of the first shoulder land portion 4A described above. According to one or more embodiments, the maximum groove widths W5 of all of the protruding portions 21 can be substantially equal to each other, for instance, in order to prevent steering sound from becoming worse.

An angle θ4 between paired groove walls 18w and 18w of the second shoulder groove portion 18 can be set to be in the same range as that for the angle θ3 of the first shoulder groove portion 5 described above. Thus, resistance to hydroplaning can be maintained while steering sound can be inhibited from becoming worse.

Although embodiments of the present disclosure have been described above in detail, the present disclosure is not limited to the illustrated embodiments, and various modifications can be devised to implement the technique of the present disclosure.

### EXAMPLES

### Example A

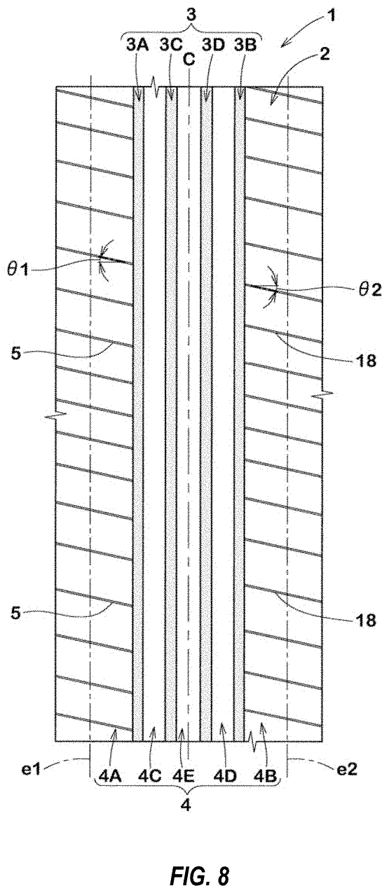

Tires shown in FIG. 1 were produced as test tires based on the specifications in Tables 1 and 2 (Example 1 to Example 7, Comparative examples 1 to 2). For comparison, a tire (conventional example 1) in which the angle θ1 of the first shoulder groove portion and the angle θ2 of the second shoulder groove portion were set to be equal to each other as shown in FIG. 8, was produced as a test tire. For each test tire, noise performance and uneven wear resistance were evaluated. The specifications were the same among the tires except for the structures indicated in Tables 1 and 2, and the tire size and the like were as indicated below. The test methods were as indicated below. The test results are indicated in Tables 1 and 2.

Tire size: 205/55R16

Rim size: 16×6.5J

Internal pressure: 230 kPa

Vehicle: electric vehicle made in Japan

Tire mounting positions: all wheels

<Noise Performance>

A test driver made sensory evaluation for noise generated at the tire when the above-described vehicle was caused to run on a dry road in a test course. The results are indicated as scores with the score of conventional example 1 being 100. The greater the value is, the better the noise performance is.

<Uneven Wear Resistance>

After the above-described vehicle was caused to run over a certain distance, a degree of uneven wear of each of the first shoulder land portion and the second shoulder land portion was visually checked and evaluated. The results are indicated as scores with the score of conventional example 1 being 100. The greater the value is, the better the uneven wear resistance is.

TABLE 1

| | Conventional | Comparative | Comparative | Example | Example | Example |
|---|---|---|---|---|---|---|
| | example 1 | example 1 | example 2 | 1 | 2 | 3 |
| Development of tread | FIG. 8 | FIG. 1 | FIG. 1 | FIG. 1 | FIG. 1 | FIG. 1 |
| Range of angle θ1, θ2 (°) | −5, 5 | −80 to 80 | −70 to 70 | −50 to 50 | −65 to 65 | −70 to 70 |
| Range of first pitch length L1 | 0.8 to 1.2 | 0.4 to 1.6 | 0.4 to 1.6 | 0.7 to 1.3 | 0.6 to 1.4 | 0.5 to 1.5 |
| Groove width W2, W4 (mm) | 0.6 | 0.6 | 0.6 | 0.6 | 0.6 | 0.6 |
| Noise performance (score) | 100 | 105 | 104 | 105 | 106 | 108 |
| Uneven wear resistance (score) | 100 | 93 | 94 | 100 | 100 | 100 |
| Overall evaluation (score) | 200 | 198 | 198 | 205 | 206 | 208 |

TABLE 2

| | Example 4 | Example 5 | Example 6 | Example 7 |
|---|---|---|---|---|
| Development of tread | FIG. 1 | FIG. 1 | FIG. 1 | FIG. 1 |
| Ranges of angle θ1, θ2 (°) | −65 to 65 | −65 to 65 | −65 to 65 | −65 to 65 |
| Range of first pitch | 0.6 to 1.4 | 0.6 to 1.4 | 0.6 to 1.4 | 0.6 to 1.4 |
| length L1 | | | | |
| Groove width W2, W4 | 0.2 | 0.8 | 1.0 | 1.5 |
| (mm) | | | | |
| Noise performance (score) | 107 | 104 | 103 | 102 |
| Uneven wear resistance | 102 | 100 | 100 | 99 |
| (score) | | | | |
| Overall evaluation (score) | 209 | 204 | 203 | 201 |

The test results indicate that noise performance was enhanced without degrading uneven wear resistance in the tires of the examples as compared with the tires of the conventional example and the comparative examples.

### Example B

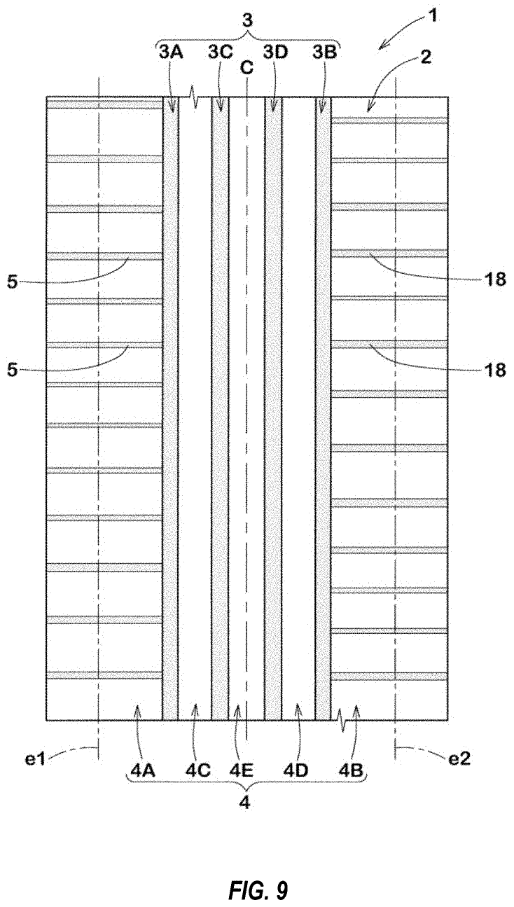

Tires shown in FIG. 5 were produced as sample tires based on the specifications in Table 3 (Example 8 to Example 13, Comparative examples 3 to 4). For comparison, a tire (conventional example 2) in which the angle θ1 of the first shoulder groove portion and the angle θ2 of the second shoulder groove portion were set to be equal to each other as shown in FIG. 9, was produced as a test tire. For each test tire, noise performance and uneven wear resistance were evaluated.

The specifications were the same among the tires except for the structures indicated in Table 3, and the tire size and the like were as indicated for Example A. The test methods were the same as those for Example A except for the matter indicated below. The test results are indicated as scores with the score of Conventional example 2 being 100. The test results are indicated in Table 3.

<Resistance to Hydroplaning>

A test driver made sensory evaluation for running performance when the above-described vehicle was caused to run on a wet road surface. The results are indicated as scores with the score of Conventional example 2 being 100. The greater the value is, the more excellent resistance to hydroplaning (wet performance) is.

<Steering Noise Performance>

A test driver made sensory evaluation for steering sound generated when the above-described vehicle was caused to run and perform cornering on a dry road in a test course. The results are indicated as scores with the score of Conventional example 2 being 100. The greater the value is, the better the steering noise performance is.

TABLE 3

| | Conventional | Example | Comparative | Comparative | Example | Example | Example | Example | Example |
|---|---|---|---|---|---|---|---|---|---|
| | example 2 | 8 | example 3 | example 4 | 9 | 10 | 11 | 12 | 13 |
| Development of tread | FIG. 9 | FIG. 5 | FIG. 5 | FIG. 5 | FIG. 5 | FIG. 5 | FIG. 5 | FIG. 5 | FIG. 5 |
| Range of angle θ1, θ2 (°) | 0 | −65 to 65 | −80 to 80 | −70 to 70 | −50 to 50 | −65 to 65 | −70 to 70 | −70 to 70 | −70 to 70 |
| Range of first pitch length L1 | 0.8 to 1.2 | 0.6 to 1.4 | 0.4 to 1.6 | 0.4 to 1.6 | 0.7 to 1.3 | 0.6 to 1.4 | 0.5 to 1.5 | 0.5 to 1.5 | 0.5 to 1.5 |
| Whether or not groove width | not | not | gradually | gradually | gradually | gradually | gradually | gradually | gradually |
| W2, W4 was gradually increased | gradually | gradually | increased | increased | increased | increased | increased | increased | increased |
| | increased | increased | | | | | | | |
| Maximum groove width W3, | 3.2 | 3.2 to 4.4 | 6.4 | 6.4 | 6.4 | 6.4 | 6.4 | 6.4 to 8.8 | 6.4 |
| W5 (mm) of protruding portion | | | | | | | | | |
| Whether or not groove volume | gradually | gradually | gradually | gradually | gradually | gradually | gradually | gradually | not |
| was gradually increased | increased | increased | increased | increased | increased | increased | increased | increased | gradually |
| (in proportion to angle θ1, θ2) | | | | | | | | | increased |
| Noise performance (score) | 100 | 103 | 105 | 104 | 105 | 106 | 107 | 106 | 107 |
| Resistance to hydroplaning | 100 | 100 | 100 | 100 | 100 | 100 | 100 | 100 | 95 |
| (score) | | | | | | | | | |
| Steering noise performance | 100 | 100 | 100 | 100 | 100 | 100 | 100 | 98 | 100 |
| (score) | | | | | | | | | |
| Uneven wear resistance (score) | 100 | 99 | 94 | 95 | 100 | 100 | 100 | 100 | 100 |
| Overall evaluation (score) | 400 | 402 | 399 | 399 | 405 | 406 | 407 | 404 | 402 |

The test results indicate that noise performance was enhanced without degrading uneven wear resistance in the tires of the examples as compared with the tires of the conventional example and the comparative examples. In the examples in which the maximum groove width of the protruding portion was set in a preferable range, steering sound was inhibited from becoming worse. Furthermore, in the examples in which the groove volumes of the first shoulder groove portion and the second shoulder groove portion were increased in proportion to the angles θ1, θ2, resistance to hydroplaning was enhanced.

[Appendix]

The present disclosure includes the following aspects.

[Disclosure 1]

A tire including a tread portion, in which

the tread portion includes a first tread ground contact end on one side in a tire axial direction, a first shoulder circumferential groove disposed closest to the first tread ground contact end, and a first shoulder land portion demarcated to be disposed outwardly of the first shoulder circumferential groove in the tire axial direction,

a plurality of first shoulder groove-like portions (i.e., groove portions) extending from the first shoulder circumferential groove to the first tread ground contact end is disposed in the first shoulder land portion,

a pair of first shoulder groove-like portions (i.e., groove portions) adjacent to each other in a tire circumferential direction among the plurality of first shoulder groove-like portions have different angles θ1 relative to the tire axial direction,

the plurality of first shoulder groove-like portions includes a plurality of kinds of first shoulder groove-like portions having different first pitch lengths each representing a pitch length in the tire circumferential direction at a connecting portion to the first shoulder circumferential groove, and

a maximum value of the first pitch length is 1.2 to 1.5 times an average of the first pitch lengths.
[Disclosure 2]

In the tire according to disclosure 1, a minimum value of the first pitch length is 0.5 to 0.8 times the average of the first pitch lengths.
[Disclosure 3]

In the tire according to disclosure 1 or 2, the angle θ1 is −70 to 70° when an angle representing inclination to one side in the tire circumferential direction is set as having a positive value.
[Disclosure 4]

In the tire according to any one of disclosures 1 to 3,

a plurality of first units formed of a part of the first shoulder groove-like portions among the plurality of first shoulder groove-like portions are aligned in the tire circumferential direction in the first shoulder land portion, and

the first units each include

a first portion in which the first shoulder groove-like portions that have the angles θ1 indicating positive values when an angle representing inclination to one side in the tire circumferential direction is set as having a positive value, are continuously disposed, and

a second portion in which the first shoulder groove-like portions that have the angles θ1 indicating negative values are continuously disposed.
[Disclosure 5]

In the tire according to disclosure 4, each first unit further includes a third portion including the first shoulder groove-like portion that has the angle θ1 indicating zero.
[Disclosure 6]

In the tire according to disclosure 4 or 5, the angles θ1 of the first shoulder groove-like portions of each of the first portion and the second portion continuously vary between a maximum value and a minimum value of the angle.
[Disclosure 7]

In the tire according to any one of disclosures 1 to 6, a second pitch length that is a pitch length, in the tire circumferential direction, for the plurality of first shoulder groove-like portions at a center position, in the tire axial direction, of the first shoulder land portion, is substantially constant.
[Disclosure 8]

In the tire according to any one of disclosures 1 to 7,

the first shoulder land portion includes a plurality of first shoulder blocks demarcated by the plurality of first shoulder groove-like portions, and

areas of tread surfaces of the plurality of first shoulder blocks are substantially equal to each other.
[Disclosure 9]

In the tire according to any one of disclosures 1 to 8, the plurality of first shoulder groove-like portions are sipes each having a groove width of not greater than 1.0 mm.
[Disclosure 10]

In the tire according to any one of disclosures 1 to 8, the plurality of first shoulder groove-like portions are lateral grooves each having a groove width of greater than 1.0 mm.
[Disclosure 11]

In the tire according to disclosure 10, the groove width is gradually increased from the first shoulder circumferential groove toward the first tread ground contact end.
[Disclosure 12]

In the tire according to disclosure 10 or 11, each of the plurality of first shoulder groove-like portions has a groove volume increased in proportion to the angle θ1.
[Disclosure 13]

In the tire according to any one of disclosures 10 to 12,

each of the plurality of first shoulder groove-like portions includes a protruding portion extending outwardly from the first tread ground contact end in the tire axial direction, and

a maximum groove width of the protruding portion is not greater than 7.0 mm.
[Disclosure 14]

In the tire according to any one of disclosures 1 to 13,

the tread portion includes a second tread ground contact end on another side in the tire axial direction, a second shoulder circumferential groove disposed closest to the second tread ground contact end, and a second shoulder land portion demarcated so as to be disposed outwardly of the second shoulder circumferential groove in the tire axial direction,

a plurality of second shoulder groove-like portions extending from the second shoulder circumferential groove to the second tread ground contact end is disposed in the second shoulder land portion,

a pair of second shoulder groove-like portions adjacent to each other in the tire circumferential direction among the plurality of second shoulder groove-like portions have different angles θ2 relative to the tire axial direction, and

the plurality of second shoulder groove-like portions includes a plurality of kinds of second shoulder groove-like portions having different third pitch lengths each representing a pitch length in the tire circumferential direction at a connecting portion to the second shoulder circumferential groove.
[Disclosure 15]

In the tire according to disclosure 14, the second shoulder groove-like portions and the first shoulder groove-like portions closest to the second shoulder groove-like portions in the tire circumferential direction are inclined in a same direction.
[Disclosure 16]

In the tire according to disclosure 14, the second shoulder groove-like portions and the first shoulder groove-like portions closest to the second shoulder groove-like portions in the tire circumferential direction are inclined in opposite directions.
[Disclosure 17]

In the tire according to any one of disclosures 1 to 16, the angles of the first shoulder groove portions of each of the first portion and the second portion continuously vary between a maximum value and a minimum value of the angle.
[Disclosure 18]

In the tire according to any one of disclosures 1 to 17,

at least one first set of adjacent first shoulder groove portions aligned in the tire circumferential direction in the first shoulder land portion extend at a positive angle relative to the tire circumferential direction continuously from a first end thereof to a second end thereof opposite the first end,

at least one second set of adjacent first shoulder groove portions aligned in the tire circumferential direction in the first shoulder land portion extend at a negative angle relative to the tire circumferential direction continuously from a first end to a second end opposite the first end, and

the at least one first set of adjacent first shoulder groove portions is offset in the tire circumferential direction from the at least one second set of adjacent first shoulder groove portions.
[Disclosure 19]

In the tire according to any one of disclosures 1 to 18, a third portion having one or more adjacent first shoulder grooves is between the at least one first set of adjacent first shoulder groove portions and the at least one second set of adjacent first shoulder groove portions in the tire circumferential direction.
[Disclosure 20]

In the tire according to any one of disclosures 1 to 19, each of the one or more adjacent first shoulder grooves is at a right angle relative to the tire circumferential direction.

The tire of the present disclosure has the above-described configuration, and can thus allow noise performance to be enhanced without degrading uneven wear resistance.

What is claimed is:

1. A tire comprising:
a tread portion,
wherein the tread portion includes:
a first tread ground contact end on one side in a tire axial direction,
a first shoulder circumferential groove closest to the first tread ground contact end, and
a first shoulder land portion demarcated outward of the first shoulder circumferential groove in the tire axial direction,
wherein each of a plurality of first shoulder groove portions extending from the first shoulder circumferential groove to the first tread ground contact end is disposed in the first shoulder land portion,
wherein a pair of first shoulder groove portions adjacent to each other in a tire circumferential direction among the plurality of first shoulder groove portions have different angles relative to the tire axial direction,
wherein the plurality of first shoulder groove portions includes a plurality of kinds of first shoulder groove portions having different first pitch lengths each representing a pitch length in the tire circumferential direction at a connecting portion to the first shoulder circumferential groove, and
wherein a maximum value of the first pitch length is 1.2 to 1.5 times an average of the first pitch lengths.

2. The tire according to claim 1, wherein a minimum value of the first pitch length is 0.5 to 0.8 times the average of the first pitch lengths.

3. The tire according to claim 1, wherein the angle is −70° to 70° when an angle representing inclination to one side in the tire circumferential direction is set as having a positive value.

4. The tire according to claim 1,
wherein a plurality of first units formed of a part of the first shoulder groove portions among the plurality of first shoulder groove portions are aligned in the tire circumferential direction in the first shoulder land portion, and
wherein the first units each include:
a first portion in which the first shoulder groove portions that have the angles indicating positive values when an angle representing inclination to one side in the tire circumferential direction is set as having a positive value, are continuously disposed, and
a second portion in which the first shoulder groove portions that have the angles indicating negative values are continuously disposed.

5. The tire according to claim 4, wherein each first unit further comprises a third portion including the first shoulder groove portion that has the angle indicating zero.

6. The tire according to claim 4, wherein the angles of the first shoulder groove portions of each of the first portion and the second portion continuously vary between a maximum value and a minimum value of the angle.

7. The tire according to claim 1, wherein a second pitch length that is a pitch length, in the tire circumferential direction, for the plurality of first shoulder groove portions at a center position, in the tire axial direction, of the first shoulder land portion, is substantially constant.

8. The tire according to claim 1,
wherein the first shoulder land portion includes a plurality of first shoulder blocks demarcated by the plurality of first shoulder groove portions, and
wherein areas of tread surfaces of the plurality of first shoulder blocks are substantially equal to each other.

9. The tire according to claim 1, wherein the plurality of first shoulder groove portions are sipes each having a groove width of not greater than 1.0 mm.

10. The tire according to claim 1, wherein the plurality of first shoulder groove portions are lateral grooves each having a groove width of greater than 1.0 mm.

11. The tire according to claim 10, wherein the groove width gradually increases from the first shoulder circumferential groove toward the first tread ground contact end.

12. The tire according to claim 10, wherein each of the plurality of first shoulder groove portions has a groove volume that increases in proportion to the angle.

13. The tire according to claim 10,
wherein each of the plurality of first shoulder groove portions includes a protruding portion extending outwardly from the first tread ground contact end in the tire axial direction, and
wherein a maximum groove width of the protruding portion is not greater than 7.0 mm.

14. The tire according to claim 1,
wherein the tread portion includes a second tread ground contact end on another side in the tire axial direction, a second shoulder circumferential groove closest to the second tread ground contact end, and a second shoulder land portion demarcated outward of the second shoulder circumferential groove in the tire axial direction,
wherein a plurality of second shoulder groove portions extending from the second shoulder circumferential groove to the second tread ground contact end is in the second shoulder land portion,
wherein a pair of second shoulder groove portions adjacent to each other in the tire circumferential direction among the plurality of second shoulder groove portions have different angles relative to the tire axial direction, and
wherein the plurality of second shoulder groove portions a includes plurality of kinds of second shoulder groove portions having different third pitch lengths each representing a pitch length in the tire circumferential direction at a connecting portion to the second shoulder circumferential groove.

15. The tire according to claim 14, wherein the second shoulder groove portions and the first shoulder groove portions closest to the second shoulder groove portions in the tire circumferential direction are inclined in a same direction.

16. The tire according to claim 14, wherein the second shoulder groove portions and the first shoulder groove portions closest to the second shoulder groove portions in the tire circumferential direction are inclined in opposite directions.

17. The tire according to claim 5, wherein the angles of the first shoulder groove portions of each of the first portion and the second portion continuously vary between a maximum value and a minimum value of the angle.

18. The tire according to claim 1,
wherein at least one first set of adjacent first shoulder groove portions aligned in the tire circumferential direction in the first shoulder land portion extend at a positive angle relative to the tire circumferential direction continuously from a first end thereof to a second end thereof opposite the first end,
wherein at least one second set of adjacent first shoulder groove portions aligned in the tire circumferential direction in the first shoulder land portion extend at a negative angle relative to the tire circumferential direction continuously from a first end to a second end opposite the first end, and
wherein the at least one first set of adjacent first shoulder groove portions is offset in the tire circumferential direction from the at least one second set of adjacent first shoulder groove portions.

19. The tire according to claim 18, wherein a third portion having one or more adjacent first shoulder grooves is between the at least one first set of adjacent first shoulder groove portions and the at least one second set of adjacent first shoulder groove portions in the tire circumferential direction.

20. The tire according to claim 19, wherein each of the one or more adjacent first shoulder grooves is at a right angle relative to the tire circumferential direction.
